(19) United States
(12) Patent Application Publication
(10) Pub. No.: US 2019/0021497 A1
(43) Pub. Date: Jan. 24, 2019

(54) OVERTURN PREVENTING DEVICE

(71) Applicants: KYB CORPORATION, Minato-ku, Tokyo (JP); KYB-YS CO., LTD., Hanishina-gun, Nagano (JP)

(72) Inventors: Shinichi SEKINE, Minato-ku, Tokyo (JP); Masakazu NAKAZATO, Minato-ku, Tokyo (JP); Atsushi TOYOUCHI, Minato-ku, Tokyo (JP); Masaya UNE, Minato-ku, Tokyo (JP); Miki IMASATO, Minato-ku, Tokyo (JP); Yukiko ISHIHARA, Minato-ku, Tokyo (JP); Takahiro SENDA, Hanishina-gun, Nagano (JP)

(73) Assignees: KYB CORPORATION, Minato-ku, Tokyo (JP); KYB-YS CO., LTD., Hanishina-gun, Nagano (JP)

(21) Appl. No.: 15/755,667

(22) PCT Filed: Aug. 16, 2016
(86) PCT No.: PCT/JP2016/073935

§ 371 Date: Feb. 27, 2018

(30) Foreign Application Priority Data
Sep. 11, 2015 (JP) 2015-179291

(51) Int. Cl. A47B 97/00; F16B 12/28

(52) U.S. Cl. CPC A47B 97/00; A47B 2097/008; F16B 12/28

(57) ABSTRACT

Providing an overturn preventing device which can maintain a mounted state against earthquake or the like with multidirectional shaking and thereby can prevent an article from overturn. The overturn preventing device includes a damper and a pair of bases. The damper is mounted between a top surface of a piece of furniture installed on a floor and a ceiling. Both ends of the damper are respectively coupled to the bases so as to be rotatable about respective rotation axes. Furthermore, both ends of the damper are respectively coupled to the bases so as to be swingable in a direction intersecting a rotation direction. The first base abuts against the top surface of the furniture and the second base abuts against the ceiling.

### TECHNICAL FIELD

The present invention relates to an overturn preventing device.

### BACKGROUND ART

Patent Document 1 discloses a conventional overturn preventing device. This overturn preventing device includes a damper and a pair of bases. The damper is mounted between a top surface of a piece of furniture installed on a floor and a ceiling. The damper has two ends respectively supported by the paired bases to be rotatable about rotation axes. One of the bases abuts against the top surface of the furniture and the other base abuts against the ceiling. As a result, in this overturn preventing device, when the furniture is tilted by shaking of earthquake or the like in a direction parallel to a rotation direction of the damper, the damper is rotated about the rotation axes relative to the bases so that the bases can be maintained in abutment against the top surface of the furniture and the ceiling respectively. As a result, this overturn preventing device can apply a damping force of the damper to the furniture thereby to suppress the tilt of the furniture and prevent the furniture from overturn.

### PRIOR ART DOCUMENT

### Patent Documents

Patent Document 1: Japanese Patent Application Publication No. JP 2015-6330

### SUMMARY OF THE INVENTION

### Problem to be Overcome by the Invention

However, shaking of earthquake or the like are multidirectional. When the furniture is shaken in a direction intersecting the rotation direction of the damper, there is a possibility that the bases are detached from the top surface of the furniture or the ceiling due to the shaking since the overturn preventing device of Patent Document 1 is not configured to follow such a movement of the furniture. This overturn preventing device cannot prevent the furniture from overturn when the bases are detached from the top surface of the furniture or the ceiling and cannot be maintained in a mounted state.

The present invention was made in view of the above-described circumstances in the conventional art and has an object to provide an overturn preventing device which can maintain the mounted state against earthquake or the like with multidirectional shaking, thereby preventing an article from overturn.

### Means for Overcoming the Problem

An overturn preventing device of the present invention includes a damper and a pair of bases. The damper is mounted between a top surface of an article installed on an installation surface and a ceiling. Both ends of the damper are respectively coupled to the bases so as to be rotatable about respective rotation axes. Furthermore, both ends of the damper are respectively coupled to the bases so as to be swingable in a direction intersecting a rotation direction. One of the bases abuts against the top surface of the article, and the other base abuts against the ceiling.

The bases of the overturn preventing device of the invention may respectively have rotating shaft members and bushes. The rotating shaft members extend about the rotation axes. The rotating shaft members support both ends of the damper so that the damper is rotatable about the rotation axes. The bushes are cylindrical and the rotational shaft members are respectively inserted through the bushes. Furthermore, the bushes allow the damper to swing in the direction intersecting the rotation direction.

The bushes of the overturn preventing device of the invention may be elastic bodies.

The end of the damper may be coupled to the bush of the overturn preventing device of the invention, and the bush may have both ends having respective inner peripheral surfaces diameters of which are outwardly enlarged.

Each base of the overturn preventing device of the invention may be formed with an insertion hole through which both ends of the rotating shaft member are inserted so that the rotating shaft member is supported. The bush through which the rotating shaft member is inserted may further be inserted into the insertion hole.

Furthermore, in the overturn preventing device of the invention, both ends of the damper may respectively be coupled to the bases by ball joints.

Furthermore, the damper may be mounted to have an axis line extending from the ceiling side to the top surface side of the article, to be downwardly inclined and to extend in parallel to a direction in which the article is tilted by shaking of earthquake or the like in a planar view as viewed from above.

The article includes furniture, book shelves, refrigerators, showcases, server racks, a bed having a plurality of beds connected to each other in the up-down direction, and large sized televisions, and the like all of which have a possibility of being overturned by shaking of earthquake or the like.

### BRIEF DESCRIPTION OF THE DRAWINGS

FIG. 1 is a side view of the overturn preventing device of a first embodiment, mounted between a top surface of furniture and the ceiling;

FIG. 2 is a front view of the overturn preventing device of the first embodiment, mounted between the top surface of the furniture and the ceiling;

FIG. 3 is a partial cross section of a damper and a first base of the overturn preventing device of the first embodiment;

FIG. 4 is a perspective view of the damper, the first base, and a fall preventing part of the overturn preventing device of the first embodiment;

FIG. 5 is a partial cross section of the damper, the first base, and the fall preventing part of the first embodiment;

FIG. 6 is a partial cross section of the damper, the first base, and an angle regulator of the overturn preventing device of the first embodiment;

FIG. 7 is a rear view of the overturn preventing device of the first embodiment, maintained in a contracted state by a fixing cord;

FIG. 8 is a side view illustrating an intermediate step of mounting the overturn preventing device of the first embodiment between the top surface of the furniture and the ceiling;

FIG. 9 is a side view of the overturn preventing device of the first embodiment, illustrating a state where the fall preventing part is caught on a wall surface;

FIG. 10 is a partial cross section of the damper and the first base of the overturn preventing device of a second embodiment;

FIG. 11 is a side view of the damper and the first base of the overturn preventing device of a third embodiment; and

FIG. 12 is a partial cross section of the damper and the first base of the overturn preventing device of the third embodiment.

### BEST MODE FOR CARRYING OUT THE INVENTION

First to third embodiments of the overturn preventing device of the present invention will be described with reference to the drawings.

### First Embodiment

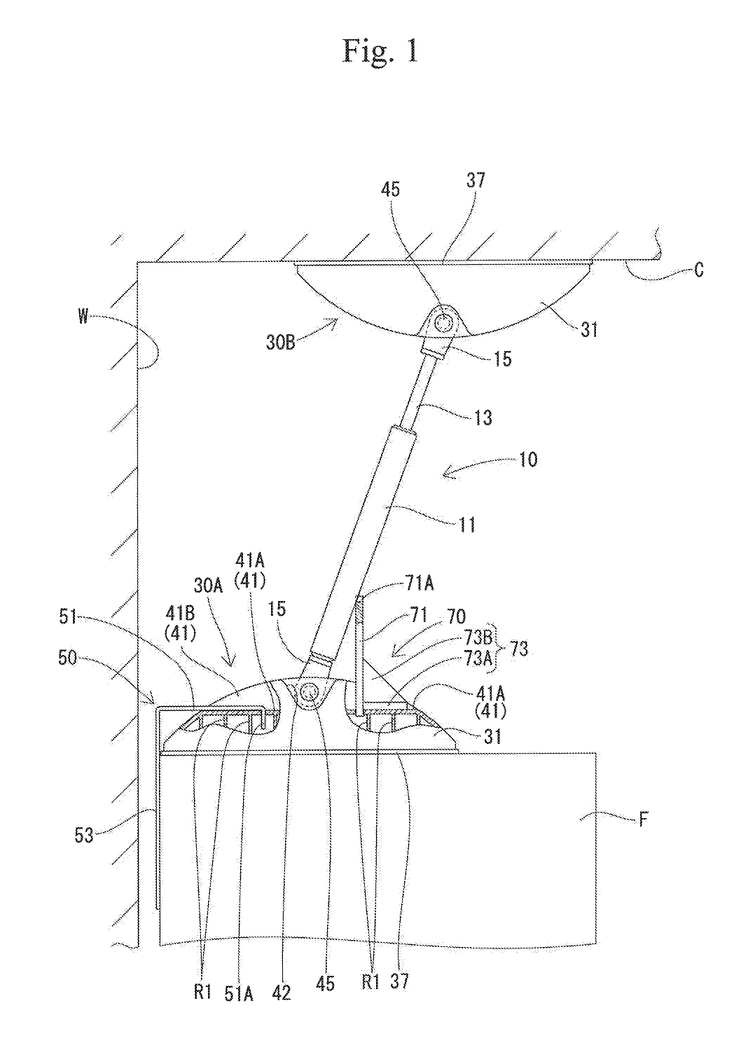

At least one overturn preventing device of the first embodiment is mounted between a top surface of a piece of furniture F and a ceiling C, as illustrated in FIG. 1. The furniture F is installed on a floor surface (not illustrated) while a rear surface of the furniture F is opposed to a wall surface W extending in a vertical direction from the floor surface. The furniture F is formed into a rectangular parallelepiped shape and has a door, drawers (neither illustrated) and the like in a front surface (a right side as viewed in FIG. 1), so that clothes, accessories and the like can be housed in the furniture F. The furniture F has a rectangle-shaped horizontal section long in a right-left direction (a depthwise direction in FIG. 1). When the overturn preventing device is not mounted on the furniture F, the furniture F would possibly be tilted frontward (rightward in FIG. 1) by shaking of earthquake or the like thereby to be overturned.

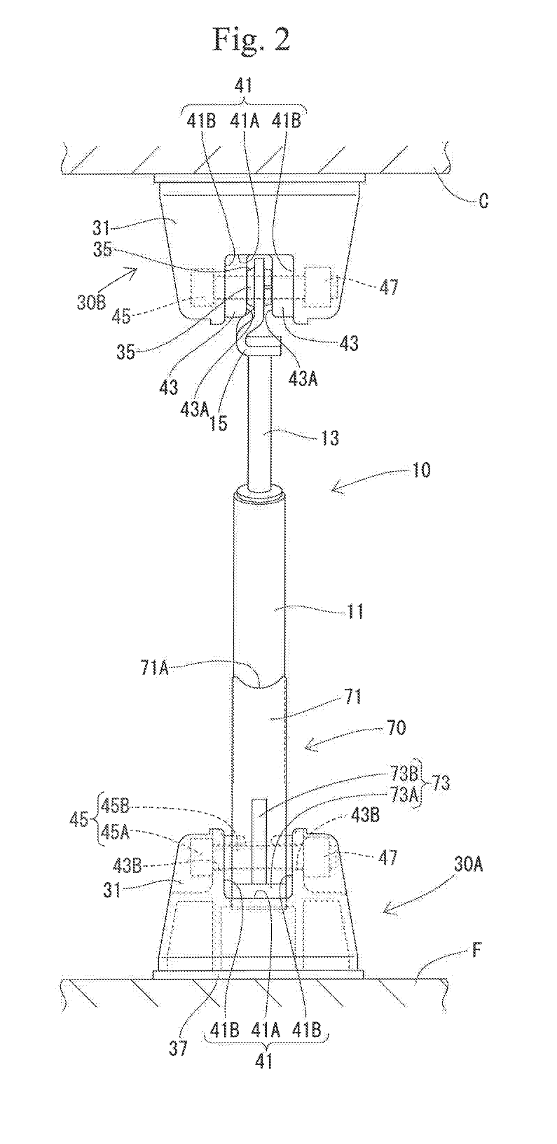

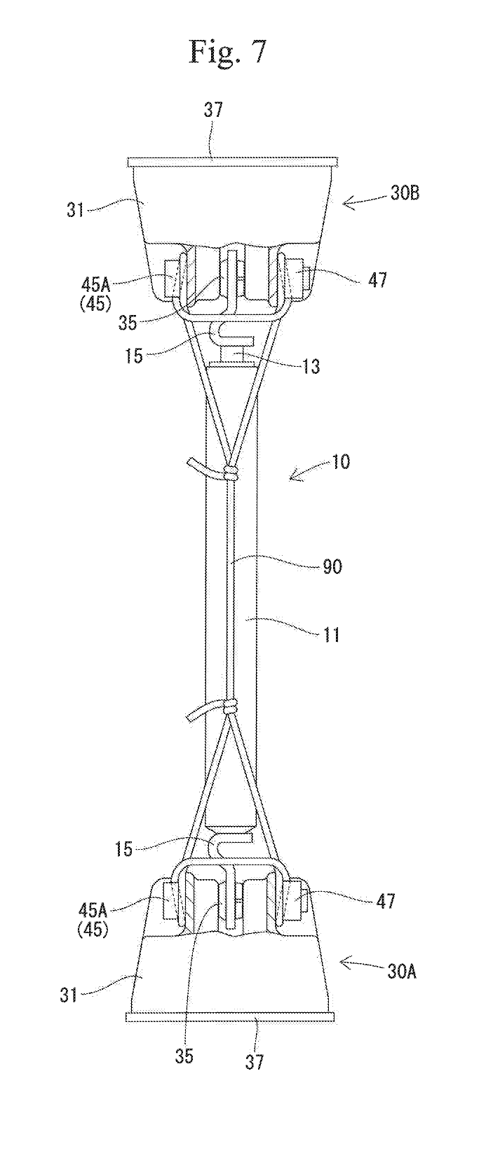

The overturn preventing device includes a damper 10, a pair of bases 30A and 30B, a fall preventing part 50, and an angle regulator 70, as illustrated in FIGS. 1 and 2. The overturn preventing device further includes a fixing cord 90 as illustrated in FIG. 7.

The damper 10 has a cylinder 11, a rod guide (not illustrated), a piston (not illustrated), a rod 13, and two joints 15 respectively provided on both ends of the damper 10. The cylinder 11 is bottomed and has a cylindrical shape. The rod guide closes an opening of the cylinder 11. The piston is slidably inserted in the cylinder 11. The rod 13 has a proximal end connected to the piston. The rod 13 is inserted through the rod guide, so that a distal end thereof protrudes out of the cylinder 11. The cylinder 11 is filled with a hydraulic fluid and a compressed gas. Each joint 15 is formed by bending a flat plate-shaped metal fitting as illustrated in FIGS. 1 to 3. The joints 15 are respectively connected to a bottom of the cylinder 10 and the distal end of the rod 13. Each joint 15 is formed with a through hole 15A extending therethrough in a direction perpendicular to an axis line of the damper 10.

The damper 10 is a compression damper in which a damping force generated during an extending operation is smaller than a damping force generated during a contracting operation. The extending operation of the damper 10 refers to an operation which increases an amount of protrusion of the rod 13 out of the cylinder 11 and the length of the damper 10. The contracting operation of the damper 10 refers to an operation which reduces an amount of protrusion of the rod 13 out of the cylinder 11 and the length of the damper 10. An expansion force of the compressed gas enclosed in the cylinder 11 works in an extension direction of the damper 10.

The following will describe a mechanism of generating a damping force by the damper 10. Since the mechanism has a known structure, diagrammatic representation is eliminated. The cylinder 11 has an interior divided by the piston into a rod side pressure chamber in which the proximal end of the rod 13 is housed and a counter-rod side pressure chamber. The piston is formed with an orifice which is a throttle valve communicating between both pressure chambers. The orifice functions as a damping force generator which applies resistance to a flow of the hydraulic fluid between the rod side pressure chamber and the counter-rod side pressure chamber with the extending/contracting operation of the damper 10. Furthermore, the piston is formed with a communication path communicating with both pressure chambers via a check valve. The check valve allows the hydraulic fluid to flow from the rod side pressure chamber to the counter-rod side pressure chamber and blocks reverse flow of the hydraulic fluid. Accordingly, the damper 10 has two flow paths of the hydraulic fluid from the rod side pressure chamber to the counter-rod side pressure chamber during the extending operation, that is, one flow path including the orifice and the other flow path including the communication path. On the other hand, the damper 10 has only one flow path of the hydraulic fluid from the counter-rod side pressure chamber to the rod side pressure chamber through the orifice during the contracting operation. Accordingly, the damping force generated by the damper 10 during the extending operation is smaller than the damping force generated by the damper 10 during the contracting operation.

The paired bases 30A and 30B are respectively a first base 30A to which the joint 15 connected to the bottom of the cylinder 11 is coupled and a second base 30B to which the joint 15 connected to a distal end of the rod 13 is coupled, as illustrated in FIGS. 1 and 2. The first base 30A is placed in abutment on the top surface of the furniture F, and the second base 30B abuts against the ceiling. The first and second bases 30A and 30B have the same form and the same structure. Each of the bases 30A and 30B has a base body 31, a bolt 45 and a nut 47 serving as a rotating shaft member, a bush 35, and a slip preventing part 37, as illustrated in FIGS. 1 to 4.

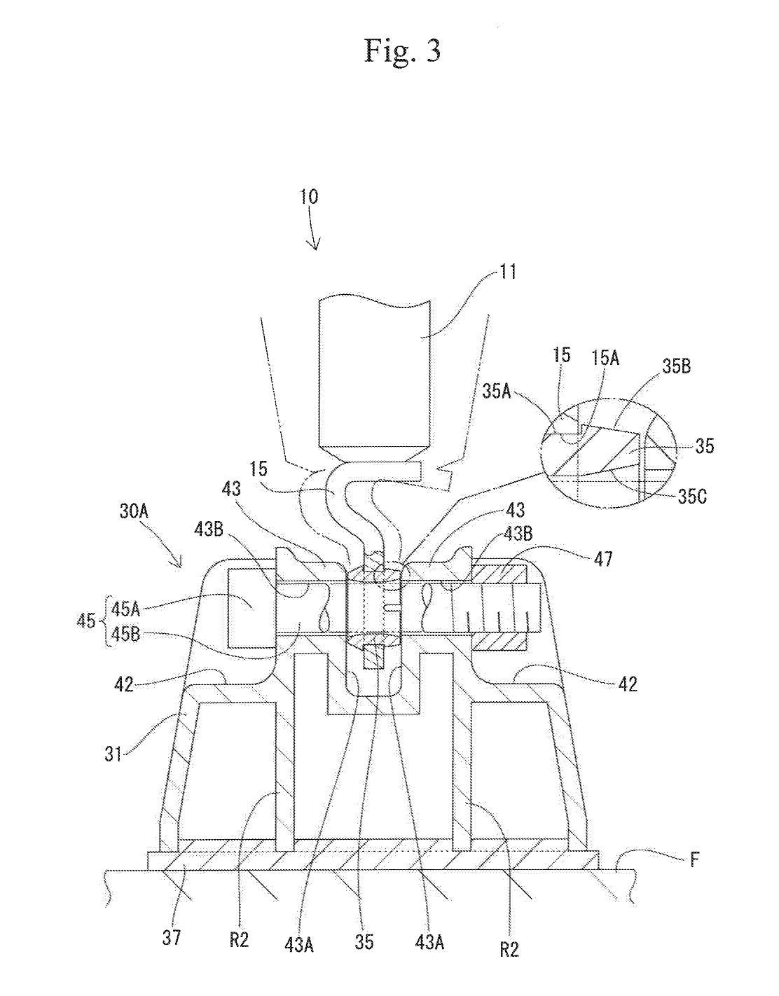

The base body 31 has a rectangular outer shape in a planar view as viewed from above in a state where the first base 30A is placed in abutment on the top surface of the furniture F (hereinafter, a direction in which a long side in the outer shape of the base body 31 extends in this planar view will be referred to as “a long side direction” and a direction in which a short side extends will be referred to as “a short side direction”). Furthermore, in a side view of the first base 30A as viewed in the short side direction in the state where the first base 30A is placed in abutment on the top surface of the furniture F, the base body 31 has a lower edge which extends straightforward in parallel to the top surface of the furniture F and an upper edge which upwardly bulges from both sides of the lower edge thereby to have an arc-shaped outer shape (refer to FIG. 1). Still furthermore, in a side view of the first base 30A as viewed in the long side direction in the state where the first base 30A is placed in abutment on the top surface of the furniture F, the base body 31 has a trapezoidal outer shape in which the upper edge is shorter than the lower edge (refer to FIGS. 2 and 3).

In the first base 30A placed in abutment on the top surface of the furniture F, the base body 31 has a groove 41 which is formed in an upper surface thereof and extends in the long side direction (a right-left direction as viewed in FIG. 1 and a depthwise direction as viewed in FIGS. 2 and 3). The groove 41 has a bottom 41A spreading on a horizontal surface and inner wall surfaces 41B respectively rising from both sides of the bottom 41A substantially in a vertical direction. The bottom 41A of the groove 41 extends substantially at a middle of the base body 31 in the up-down direction. Furthermore, the bottom 41A of the groove 41 has a constant width except for a portion formed with a pair of convex portions 43 which will be described later.

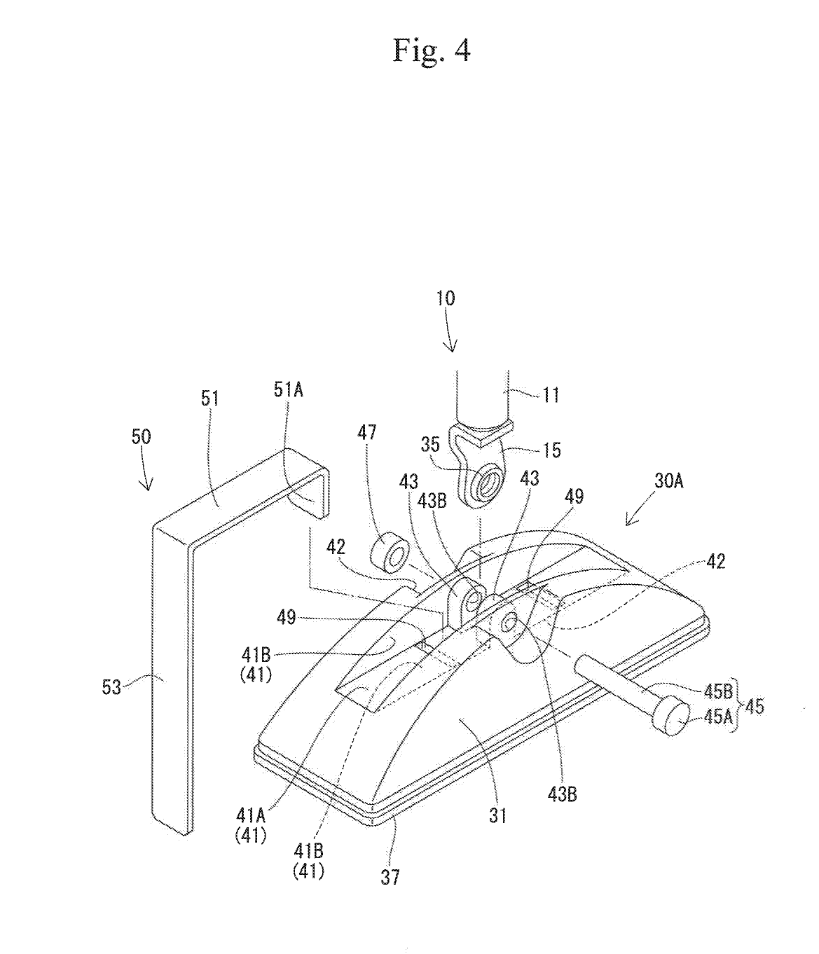

The groove 41 has the paired convex portions 43 which are formed at a central part thereof in the long side direction to protrude from the bottom 41A and both inner wall surfaces 41B of the groove 41, as illustrated in FIG. 4. A space is defined between the convex portions 43 as illustrated in FIGS. 2 and 3. The joint 15 of the damper 10 and a bush 35 which will be described later are fitted into the space. The space communicates with the groove 41. A distance (a dimension of the space in the short side direction) between the inner wall surfaces 43A of the convex portions 43 is slightly longer than a length of the bush 35. Furthermore, the convex portions 43 respectively have insertion holes 43B which are formed to extend through upper central parts thereof in the short side direction and through which a shaft part 45B of the bolt 45, which will be described later, is inserted.

A pair of locked holes 49 having the same configuration is formed in the bottom 41A of the groove 41 as illustrated in FIG. 4. The locked holes 49 are formed so that respective distances from the convex portions 43 toward both ends of the groove 41 are substantially equal to each other. Each locked hole 49 has the shape of a slit extending over an entire width of the groove 41. In other words, each locked hole 49 has a length equal to the width of the groove 41 and a width that is slightly larger than a thickness of a locking part 51A of the fall preventing part 50 and a thickness of an insertion part 71B provided in the angle regulator 70 which will be described later. One of the locked holes 49 serves as a locked part into which the locking part 51A of the fall preventing part 50 is inserted thereby to be locked. The other locked hole 49 serves as a locked part into which the insertion part 71B provided in the angle regulator 70 is inserted thereby to be locked.

In the first base 30A placed in abutment on the top surface of the furniture F, the base body 31 has recesses 42 respectively formed in both sides of the groove 41 in the middle in the long side direction. The recesses 42 are each open upward and outward with respect to the short side direction. The recesses 42 each have a side in which the insertion hole 43B formed through the convex portion 43 is open. A head 45A of the bolt 45 and the nut 47 screwed onto the bolt 45 which will be described later are respectively disposed in the recesses 42. The recesses 42 are formed to be upwardly spread in the long side direction so that tools can be fitted with the bolt head 45A and the nut 47 from above.

The base body 31 is hollow as illustrated in FIGS. 1 to 3. Furthermore, the base body 31 is downwardly open in the first base 30A placed in abutment on the top surface of the furniture F. The base body 31 has a plurality of ribs R1 extending in parallel to the short side direction in the inside thereof and two ribs R2 extending in parallel to the long side direction in the inside thereof so that the ribs R1 and the ribs R2 intersect with each other.

The rotating shaft member includes the bolt 45 inserted from one of the insertion holes 43B of the base body 31 and the nut 47 screwed onto the shaft part 45B of the bolt 45, as illustrated in FIGS. 2 and 3. Central axes of the respective bolts 45 serve as rotation axes of the damper 10 in the bases 30A and 30B.

The bush 35 is substantially cylindrical in shape as illustrated in FIG. 3. The bush 35 is an elastic body. The bush 35 has a length that is slightly smaller than a distance between the inner wall surfaces 43A of the paired convex portions 43 provided in the base body 31. The bush 35 is formed with a concave portion 35A going around a central part of the outer peripheral surface thereof. The concave portion 35A has an outer diameter that substantially equals an inner diameter of the through hole 15A formed through the joint 15 of the damper 10. The bush 35 has portions rising from both ends of the concave portion 35A which portions have outer diameters larger than the inner diameter of the through hole 15A of the joint 15. Furthermore, both ends of the bush 35 have respective outer peripheral surfaces 35B the diameters of which are outwardly reduced. As a result, the bush 35 is inserted into the through hole 15A of the joint 15 of the damper 10 while being elastically deformed. The concave portion 35A is then fitted into the through hole 15A so that the bush 35 is attached to the joint 15 of the damper 10.

The central part of the bush 35 has an inner diameter slightly larger than an outer diameter of the shaft part 45B of the bolt 45. Both ends of the bush 35 have inner peripheral surfaces 35C the diameters of which are outwardly enlarged. Accordingly, the bush 35 is rotatable about the shaft part 45B of the bolt 45. Furthermore, the bush 35 is inclinable with respect to the shaft part 45B of the bolt 45 to the extent that the inner peripheral surfaces 35C of both ends thereof having enlarged diameters abut against an outer peripheral surface of the shaft part 45B of the bolt 45. In other words, the damper 10 with the bush 35 attached to the joint 15 is rotatable about the shaft part 45B of the bolt 45 and swingable in a direction intersecting the rotation direction. Furthermore, by the elastic deformation of the bush 35, the damper 10 can be swung more largely in the direction intersecting the rotation direction.

The slip preventing part 37 has an outer shape which is similar to and slightly larger than the outer shape of the base body 31 (a rectangular shape), as illustrated in FIGS. 1 to 4. The slip preventing part 37 is made of rubber. In the first base 30A placed in abutment on the top surface of the furniture F, the slip preventing part 37 is fitted in a lower opening of the base body 31. Furthermore, the slip preventing part 37 is substantially flat in shape. In more detail, in the slip preventing part 37, a surface which abuts against the top surface of the furniture F or the ceiling C is flat, and an oppositely directed surface (the surface opposed to the base body 31) is formed with a fitting groove according to an outer peripheral wall of the base body 31 and the ribs R1 and R2. The slip preventing part 37 is detachably attached to the base body 31 by an elastic force thereof.

The following will describe a step of assembling the damper 10 with the bases 30A and 30B.

First, the bushes 35 are respectively fitted into the through holes 15A formed through the two joints 15 provided at both ends of the damper 10 thereby to be attached to the joints 15 of the damper 10.

Next, one of the joints 15 of the damper 10 attached with the bush 35 is inserted between the paired convex portions 43 formed on the base body 31. The shaft part 45B of the bolt 45 is then inserted through the insertion holes 43B of the base body 31 and the bush 35, and the nut 47 is screwed onto the shaft part 45B of the bolt 45. The base body 31 is thus coupled to one of the joints 15 of the damper 10. The other joint 15 of the damper 10 is also coupled to the other base body 31 in the similar manner. In this state, as illustrated in FIG. 2, the heads 45A of the bolts 45 and the nuts 47 (both ends of the rotating shaft members) are respectively exposed in the recesses 42 of the base bodies 31 at positions symmetrical with respect to a central axis of the damper 10.

Then, the slip preventing parts 37 are respectively fitted with the base bodies 31 coupled to both ends of the damper 10, so that the step of assembling the damper 10 with the bases 30A and 30B is finished.

In the damper 10 and the bases 30A and 30B thus assembled, the bushes 35 are respectively rotatable relative to the shaft parts 45B of the bolts 45 as illustrated in FIG. 3. Accordingly, both ends of the damper 10 are respectively coupled to the bases 30A and 30B so as to be rotatable about the rotation axes. Furthermore, both ends of the bush 35 have the inner peripheral surfaces 35C the diameters of which are outwardly enlarged. Accordingly, the bush 35 is inclinable relative to the rotation axis to the extent that the inner peripheral surfaces 35C of both ends thereof having enlarged diameters abut against the outer peripheral surface of the shaft part 45B of the bolt 45. Furthermore, the bush 35 is an elastic body and by the elastic deformation thereof, the damper 10 can be swung more largely in a direction intersecting the rotation direction. Thus, the damper 10 coupled to the bases 30A and 30B is swingable in the direction intersecting the rotation direction.

The fall preventing part 50 is formed by bending a flat band-shaped metal as illustrated in FIGS. 1, 4, and 5. The fall preventing part 50 has a constant width that is slightly smaller than that of the groove 41 formed in the base body 31. In other words, the width of the fall preventing part 50 is slightly smaller than a length of the slit-like locked hole 49 formed in the base body 31. Furthermore, the fall preventing part 50 has a coupling part 51 and a drooping part 53. The coupling part 51 has a locking part 51A formed by bending one of ends thereof at a right angle. The drooping part 53 is continuous to the other end of the coupling part 51 and perpendicular to the coupling part 51 and extends in the same direction as the locking part 51A. The drooping part 53 of the fall preventing part 50 has a length set so as not to come out from between the wall surface W and the rear surface of the furniture F when the overturn preventing device falls in such a direction that an upper side thereof departs from the wall surface W, as described later. For example, the drooping part 53 has a length of not less than 100 mm below the slip preventing part 37.

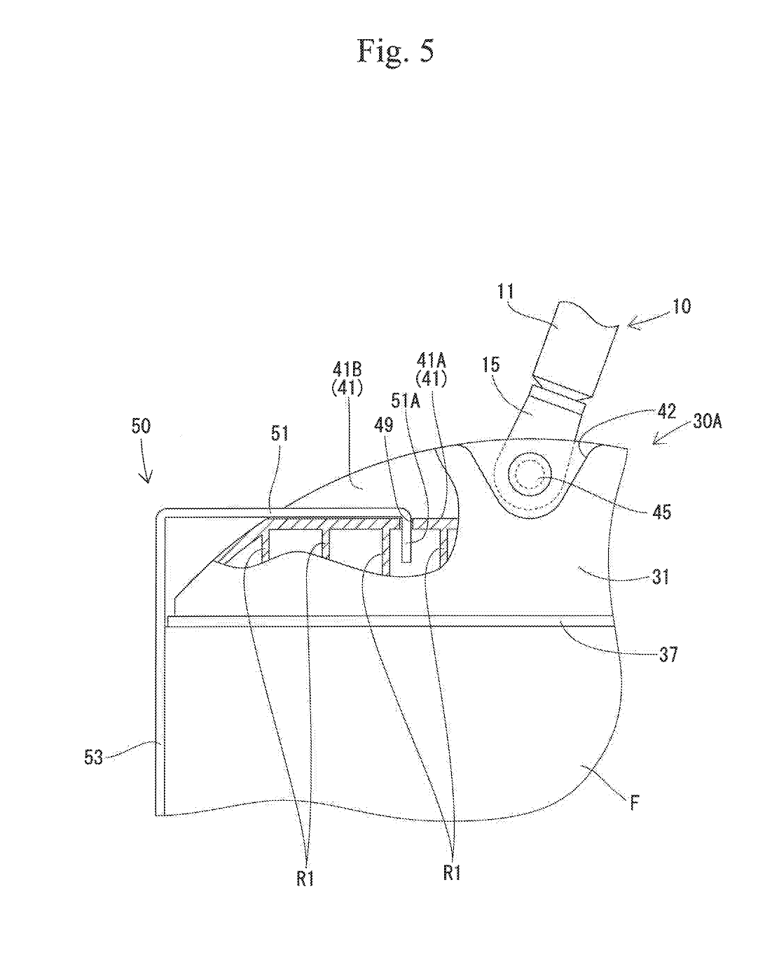

The fall preventing part 50 is attached to the first base 30A placed in abutment on the top surface of the furniture F as illustrated in FIGS. 1 and 5. In more detail, the locking part 51A of the coupling part 51 is inserted and locked in the locked hole 49 of the base body 31 of the first base 30A placed in abutment on the top surface of the furniture F, which locked hole 49 is located at the wall surface W side. Thus, the fall preventing part 50 can be easily attached to the first base 30A in this overturn preventing device. Furthermore, the fall preventing part 50 can be detached from the first base 30A during the packaging of the overturn preventing device or in other cases so that the overturn preventing device is prevented from bulking.

In a state of being attached to the base body 31 of the first base 30A, the coupling part 51 of the fall preventing part 50 extends along the groove 41 formed in the base body 31 and the other end of the coupling part 51 is located outside an outer edge of the first base 30A (an outer edge of the slip preventing part 37 of the first base 30A). The drooping part 53 droops from the other end of the coupling part 51 and extends downward slightly outside the outer edge of the slip preventing part 37 of the first base 30A. The fall preventing part 50 is disposed between the wall surface W and the rear surface of the furniture F below the first base 30A.

The angle regulator 70 is detachably attached to the first base 30A placed in abutment on the top surface of the furniture F as illustrated in FIGS. 1, 2, and 6. As a result, the angle regulator 70 can be detached from the first base 30A during the packaging of the overturn preventing device or in other cases so that the overturn preventing device is prevented from bulking. In a state of being attached to the first base 30A, the angle regulator 70 has a regulating part 71 which extends substantially vertically, and a support part 73 which is provided to be continuous from a lower part of the regulating part 71 and prevents the regulating part 71 from being inclined. The regulating part 71 is a flat plate and is substantially rectangular in shape. When the angle regulator 70 is attached to the first base 30A placed in abutment on the top surface of the furniture F, one of short side ends of the regulating part 71 serves as a receiving part 71A located at an upper end, and the other short side end is located at a lower end and serves as the insertion part 71B which is inserted into the locked hole 49 of the base body 31 located at the side away from the wall surface W.

The regulating part 71 causes the cylinder 11 of the damper 10 to abut against the receiving part 71A thereby regulating the damper 10 so as not to fall in excess of the inclined state. An inclination angle of the damper 10 preferably ranges from 15° to 25°. The receiving part 71A is upwardly open and curved so as to be downwardly recessed at a central part thereof so that one third of the outer periphery of the cylinder 11 abuts thereagainst. Thus, since the cylinder 11 is not held tightly by the receiving part 71A, the movement of the damper 10 is not restrained when the furniture F is tilted or shaken by shaking of earthquake or the like. In other words, in this overturn preventing device, the damper 10 is rotatable about the rotation axes relative to the bases 30A and 30B and swingable in the direction intersecting the rotation direction when the furniture F is shaken or tilted by shaking of earthquake or the like.

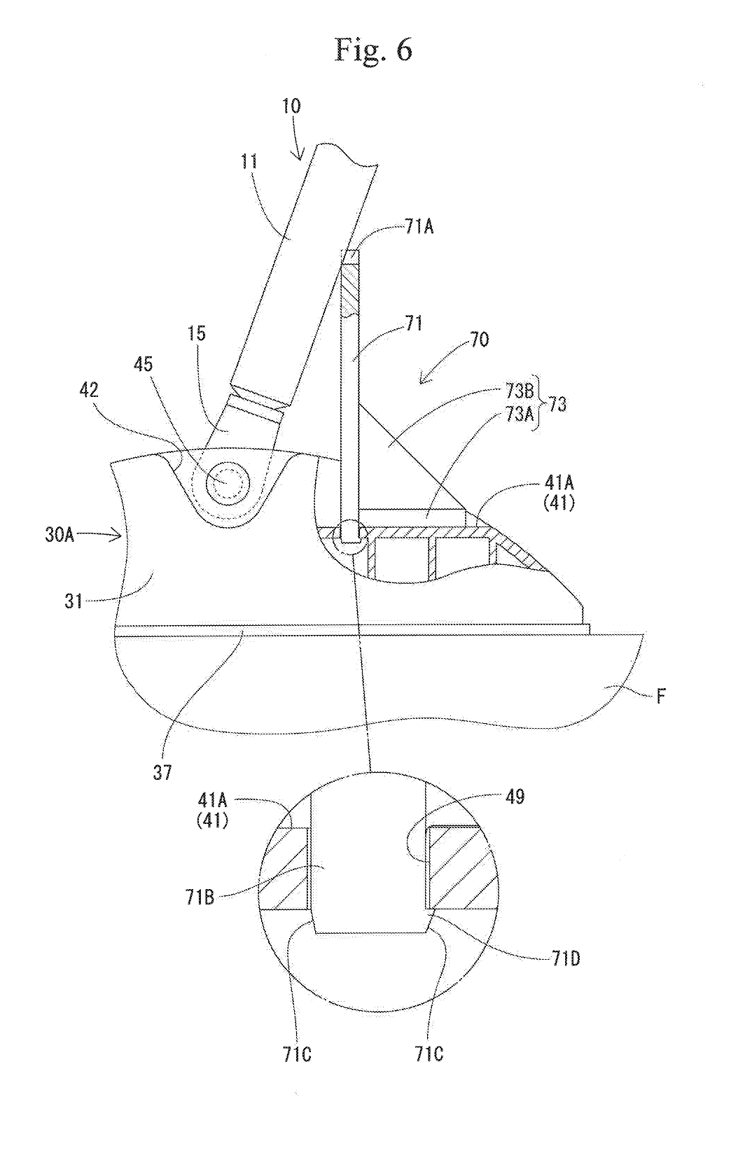

The insertion part 71B has inclined surfaces 71C respectively formed by cutting out both side corners of the short side in the long side direction so as to become thinner toward a distal end thereof, as illustrated in FIG. 6. The inclined surfaces 71C allow the insertion part 71B to be easily inserted into the locked hole 49 of the base body 31. The insertion part 71B also has a protrusion 71D protruding from one of sides of the distal end in the short side direction. The angle regulator 70 is detachable from the first base 30A. However, when a force acts on the angle regulator 70 in such a direction that the insertion part 71B is accidentally pulled out of the locked hole 49 of the base body 31, the protrusion 71D is caught by the locked hole 49, whereby the insertion part 71B is hard to pull out of the locked hole 49.

The support part 73 includes a first support part 73A and a second support part 73B. The first support part 73A has the same width as the regulating part 71 and is a flat plate extending in a direction perpendicular to the regulating part 71. The first support part 73A abuts against the bottom 41A of the groove 41 formed in the base body 31 when the insertion part 71B of the regulating part 71 is inserted into the locked hole 49 of the base body 31 of the first base 30A. The second support part 73B is a flat plate which has an isosceles right triangle shape and is coupled to a corner between the first support part 73A and the regulating part 71. In more detail, the second support part 73B has two sides having an equal length which are respectively coupled to a side surface of the first support part 73A and a side surface of the regulating part 71, thereby supporting the regulating part 71 so that the first support part 73A and the regulating part 71 are perpendicular to each other.

The overturn preventing device includes a fixing cord 90 to maintain the damper 10 in a contracted state with a desired length, as illustrated in FIG. 7. The fixing cord 90 is a string made of a chemical fiber. While the damper 10 is in a contracted state, both sides of the fixing cord 90 are respectively formed into rings, which rings are respectively caught on the heads 45A of the bolts 45 and the nuts 47 of the first and second bases 30A and 30B. In other words, the fixing cord 90 is locked on the heads 45A of the bolts 45 and the nuts 47 of the first and second bases 30A and 30B at both sides thereof and extends as a single cord in the middle thereof.

Thus, in this overturn preventing device, the damper 10 can be held in the contracted state with a desired length by use of the heads 45A of the bolts 45 and the nuts 47 respectively located at both ends of the damper 10, without providing the structure only for locking the fixing cord 90. Furthermore, in this overturn preventing device, the damper 10 can be held in contracted states with different contraction lengths by adjusting the length of the cord. As a result, even with the overturn preventing device having the same lengths of the cylinder 11 and the rod 13, it is possible to prepare a plurality of overturn preventing devices which hold the damper 10 in a plurality of contracted states with different contraction lengths according to the distance between the top surface of the furniture F and the ceiling C where the overturn preventing device is to be mounted. Furthermore, even when a standard of the length of the damper 10 is changed, the overturn preventing device can easily cope with the change by changing the length of the fixing cord 90.

When the overturn preventing device is mounted between the top surface of the furniture F and the ceiling C, the first base 30A of the overturn preventing device maintained in the contracted state by the fixing cord 90 is placed in abutment on the top surface of the furniture F. Subsequently, when the fixing cord 90 is loosened or cut, the damper 10 is extended by an expansion force of the compressed gas filling the cylinder 11 with the result that the second base 30B abuts against the ceiling C. Thus, since the worker need not carry out a mounting work to contract the damper 10 above the furniture F, the overturn preventing device can be mounted between the top surface of the furniture F and the ceiling C easily and safely.

Furthermore, if the degree of extension of the damper 10 is rendered small when the damper 10 changes from the state contracted by the fixing cord 90 to the state where the second base 30B abuts against the ceiling C, shock caused by abutment of the second base 30B against the ceiling C can be rendered small. Therefore, according to a distance between the top surface of the furniture F and the ceiling C, a plurality of types of overturn preventing devices having different lengths of the cylinder 11 and the rod 13 of the damper 10 preferably may be prepared, and furthermore, a plurality of types of overturn preventing devices having different contraction lengths of the damper 10 preferably may be prepared by use of the fixing cord 90 for the damper 10 having the same lengths of the cylinders 11 and the rods 13.

The following will describe a manner of mounting the overturn preventing device between the top surface of the furniture F installed on the floor with the rear surface thereof being opposed to the wall surface W, and the ceiling C.

First, one of the overturn preventing devices is selected which has the suitable lengths of the cylinder 11 and the rod 13 for the distance between the ceiling C and the top surface of the furniture F where the overturn preventing device is to be mounted and which has the damper 10 being maintained in the contracted state by the fixing cord 90 with an appropriate length so that shock caused by abutment of the second base 30B against the ceiling C is rendered small.

Next, the locking part 51A of the fall preventing part 50 is inserted into one of the locked holes 49 formed in the base body 31 of the first base 30A of the overturn preventing device, whereby the fall preventing part 50 is attached to the first base 30A. The insertion part 71B of the angle regulator 70 is inserted into the other locked hole 49 formed in the base body 31 of the first base 30A whereby the angle regulator 70 is attached to the first base 30A.

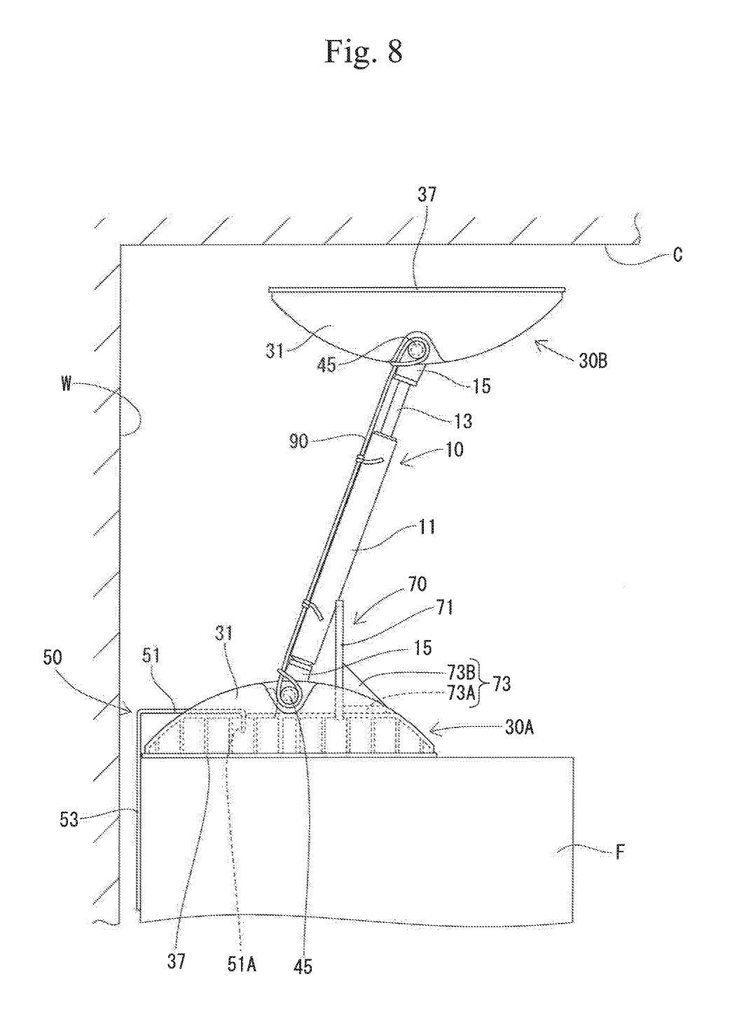

Next, the first base 30A attached with the fall preventing part 50 and the angle regulator 70 is placed with the slip preventing part 37 abutting against the top surface of the furniture F at the wall surface W side, as illustrated in FIG. 8. In this case, the first base 30A is placed on the top surface of the furniture F in such a manner that the drooping part 53 of the fall preventing part 50 droops along the rear surface of the furniture F. In other words, the drooping part 53 of the fall preventing part 50 is disposed between the wall surface W and the rear surface of the furniture F. Furthermore, in the state where the first base 30A is placed on the top surface of the furniture F, the shaft part 45B (rotation axis) of the bolt 45 of the first base 30A extends in a direction perpendicular to a direction in which the furniture F is tilted by shaking of earthquake or the like (rightward as viewed in FIG. 8). In other words, the first base 30A is placed on the top surface of the furniture F so that the direction in which the damper 10 is rotated about the rotation axes is parallel to the direction in which the furniture F is tilted.

The damper 10 is then inclined so that the cylinder 11 of the damper 10 abuts against the receiving part 71A of the angle regulator 70. In this state, the damper 10 is inclined at an appropriate angle ranging from 15° to 25°. The direction of the second base 30B is corrected so that the shaft part 45B (the rotation axis) of the bolt 45 of the second base 30B becomes parallel to the shaft part 45B (the rotation axis) of the bolt 45 of the first base 30A. When the fixing cord 90 is loosened or cut in this state, the damper 10 is extended by an expansion force of the compressed gas filling the cylinder 11, with the result that the second base 30B abuts against the ceiling C. Thus, the work for mounting the overturn preventing device between the top surface of the furniture F and the ceiling C is completed. The angle regulator 70 may be detached from the first base 30A after completion of the mounting work.

As described above, the damper 10 of the overturn preventing device can be inclined at the appropriate inclination angle by placing the first base 30A attached with the angle regulator 70 on the top surface of the furniture F, and the overturn preventing device can be mounted appropriately between the top surface of the furniture F and the ceiling C just by causing the second base 30B to abut against the ceiling C while maintaining the inclination angle of the damper 10.

In the overturn preventing device mounted between the top surface of the furniture F and the ceiling C, the damper 10 is mounted so that an axis line of the damper 10 extending from the ceiling C side to the top surface side of the furniture F is downwardly inclined and so that the axis line of the damper 10 extends in parallel to the direction in which the furniture F is tilted by shaking of earthquake or the like (rightward) in a planar view as viewed from above. Accordingly, the overturn preventing device can prevent the furniture F from overturn by effectively using the damping force of the damper 10 for the tilt of the furniture F.

Furthermore, both ends of the damper 10 are respectively coupled via the bushes 35 to the bases 30A and 30B. Each bush 35 is an elastic body and has both ends further having the inner peripheral surfaces 35C the diameters of which are outwardly enlarged. Consequently, each bush 35 can be inclined with respect to the rotation axis to the extent of elastic deformation of the bush 35 and to the extent that the inner peripheral surfaces 35C of both ends thereof having enlarged diameters abut against the outer peripheral surface of the shaft part 45B of the bolt 45. As a result, the damper 10 coupled to the bases 30A and 30B can be swung in the direction intersecting with the rotation direction.

Thus, even when the furniture F is shaken in the direction intersecting the rotation direction by shaking of earthquake or the like, the damper 10 is swung in the direction intersecting the rotation direction with the result that the bases 30A and 30B can respectively be maintained in abutment against the top surface of the furniture F and the ceiling C. When the furniture F is tilted in the direction parallel to the rotation direction of the damper 10, the damper 10 is rotated about the rotation axes so that the damping force of the damper 10 acts on the furniture F thereby suppressing tilt of the furniture F, with the result that the furniture F can be prevented from overturn. In other words, the bases 30A and 30B can be respectively maintained in abutment against the top surface of the furniture F and the ceiling C against earthquake or the like with multidirectional shaking, with the result that the furniture F can be prevented from overturn.

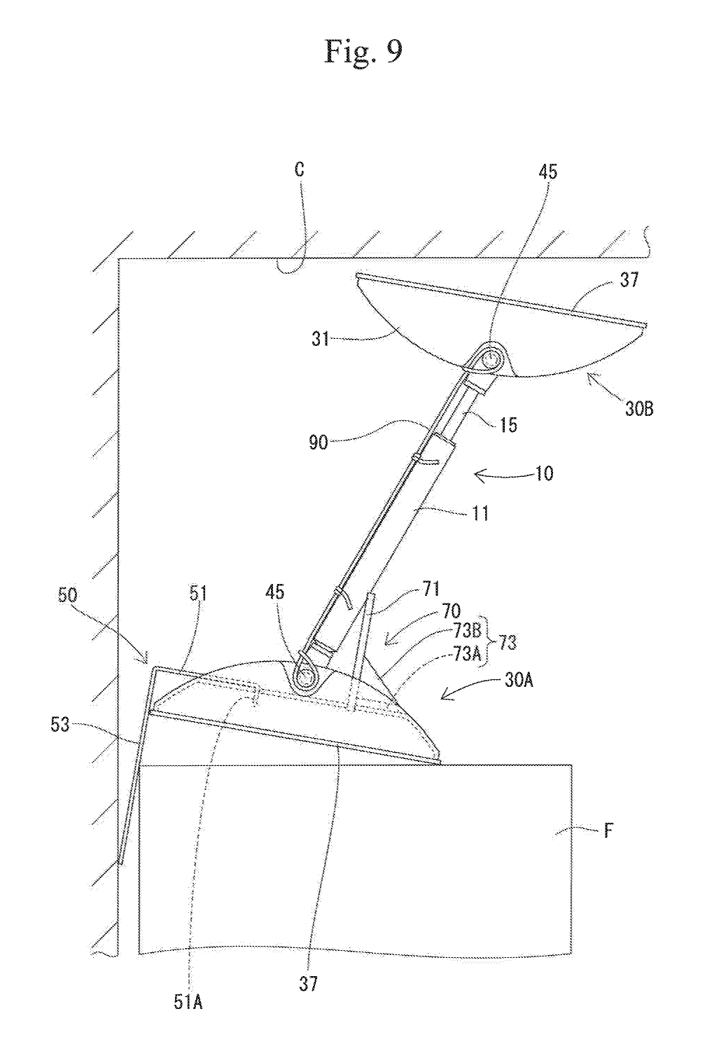

Furthermore, consider the case where the overturn preventing device falls in such a direction that the upper side thereof departs from the wall surface W before the second base 30B is caused to abut against the ceiling C during the work of mounting the overturn preventing device between the top surface of the furniture F and the ceiling C, that is, when the first base 30A is placed in abutment on the top surface of the furniture F and the drooping part 53 of the fall preventing part 50 is disposed between the wall surface W and the rear surface of the furniture F. In this case, due to the force to tilt the overturn preventing device, the wall surface W side of the first base 30A abutting against the top surface of the furniture F is caused to float. Thereupon, as illustrated in FIG. 9, the drooping part 53 of the fall preventing part 50 attached to the first base 30A is caught on the wall surface W. As a result, the overturn preventing device can be prevented from falling to the front surface side of the furniture F.

As described above, the overturn preventing device of the first embodiment includes the damper 10 and the paired bases 30A and 30B. The damper 10 is mounted between the top surface of the furniture F installed on the floor, and the ceiling C. Both ends of the damper 10 are respectively coupled to the bases 30A and 30B so as to be rotatable about the rotation axes. Furthermore, both ends of the damper 10 are respectively coupled to the bases 30A and 30B so as to be swingable in the direction intersecting the rotation direction. Furthermore, the first base 30A abuts against the top surface of the furniture F and the second base 30B abuts against the ceiling C.

In this overturn preventing device, both ends of the damper 10 are respectively coupled to the bases 30A and 30B so as to be rotatable about the rotation axes and swingable in the direction intersecting the rotation direction. Accordingly, even when the furniture F is shaken in the direction intersecting the rotation direction by shaking of earthquake or the like, the damper 10 is swung in the direction intersecting the rotation direction with the result that the bases 30A and 30B can respectively be maintained in abutment against the top surface of the furniture F and the ceiling C. When the furniture F is tilted in the direction parallel to the rotation direction of the damper 10, the damper 10 is rotated about the rotation axes so that the damping force of the damper 10 acts on the furniture F thereby suppressing tilt of the furniture F, with the result that the furniture F can be prevented from overturn. In other words, the bases 30A and 30B can be respectively maintained in abutment against the top surface of the furniture F and the ceiling C against earthquake or the like with multidirectional shaking, with the result that the furniture F can be prevented from overturn.

Accordingly, the overturn preventing device of the first embodiment can maintain the mounted state against earthquake or the like with multidirectional shaking, thereby preventing the furniture F from overturn.

The bases 30A and 30B of the overturn preventing device of the first embodiment respectively have the bolts 45 and the nuts 47 serving as the rotating shaft members, and the bushes 35. The bolts 45 extend about the rotation axes respectively. The bushes 35 are cylindrical in shape and the shaft parts 45B of the bolts 45 are respectively inserted through the bushes 35. The ends of the damper 10 are respectively coupled to the bushes 35. The bushes 35 allow the damper 10 to swing in the direction intersecting the rotation direction of the damper 10.

Consequently, the damper 10 can be rotated about the rotation axes and also swung in the direction intersecting the rotation direction by the bushes 35 in this overturn preventing device. Thus, the damper 10 is coupled to the bases 30A and 30B to be rotatable and swingable by a simple structure, with the result that the overturn preventing device can maintain the mounted state against earthquake or the like with multidirectional shaking, thereby preventing the furniture F from overturn.

Furthermore, both ends of the bush 35 of the overturn preventing device of the first embodiment have the inner peripheral surfaces 35C the diameters of which are outwardly enlarged. Accordingly, the bush 35 is inclinable relative to the rotation axis to the extent that the inner peripheral surfaces 35C of both ends thereof having enlarged diameters abut against the outer peripheral surface of the shaft part 45B of the bolt 45. In other words, the damper 10 coupled to the bases 30A and 30B can be swung in the direction intersecting the rotation direction. Thus, the damper 10 is coupled to the bases 30A and 30B so as to be rotatable and swingable by a simple structure, with the result that the overturn preventing device can maintain the mounted state against earthquake or the like with multidirectional shaking, thereby preventing the furniture F from overturn.

Furthermore, the bushes 35 of the overturn preventing device of the first embodiment are elastic bodies. Accordingly, by the elastic deformation of the bushes 35, the damper 10 coupled to the bases 30A and 30B can be swung in the direction intersecting the rotation direction. Thus, the damper 10 is coupled to the bases 30A and 30B to be rotatable and swingable by a simple structure, with the result that the overturn preventing device can maintain the mounted state against earthquake or the like with multidirectional shaking, thereby preventing the furniture F from overturn.

Furthermore, in the overturn preventing device of the first embodiment, the damper 10 is mounted so that an axis line of the damper 10 extending from the ceiling C side to the top surface side of the furniture F is downwardly inclined and so that the axis line of the damper 10 extends in parallel to the direction in which the furniture F is tilted by shaking of earthquake or the like in a planar view as viewed from above. When the damper 10 is mounted in this manner, the damping force of the damper 10 is effectively used for the tilt of the furniture F, with the result that the furniture F can be prevented from overturn.

### Second Embodiment

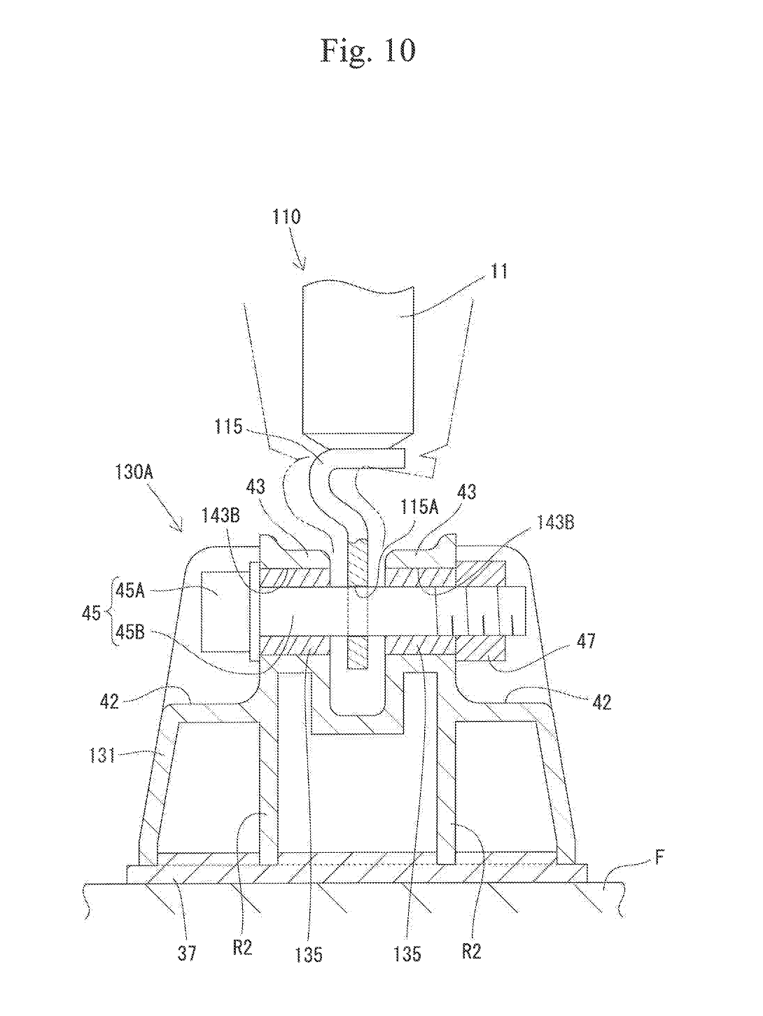

The overturn preventing device of a second embodiment differs from that of the first embodiment in the form of a joint 115 of a damper 110, the form of a base body 131, and the form and an assembly position of bushes 135, as illustrated in FIG. 10. Other components are same as those of the first embodiment. Identical or similar parts are labeled by the same reference symbols as those in the first embodiment, and the detailed description of these parts will be eliminated.

Furthermore, the manner of mounting the overturn preventing device of the second embodiment between the top surface of the furniture F and the ceiling C is same as that of the first embodiment.

In this overturn preventing device, too, a through hole 115A extends through each joint 115 in the direction perpendicular to the axis line of the damper 110. The through hole 115A has an inner diameter slightly larger than an outer diameter of the shaft part 45B of the bolt 45. As a result, the damper 110 is rotatable about the shaft part 45B of the bolt 45 but almost cannot be inclined relative to the shaft part 45B of the bolt 45.

The first base 130A placed in abutment on the top surface of the furniture F and the second base (not illustrated) abutting against the ceiling C have the same form and the same structure, and each base includes the base body 131, the bolt 45 and the nut 47 serving as the rotating shaft member, the paired bushes 135, and the slip preventing part 37. Each base body 131 has insertion holes 143B which respectively extend through upper central parts of the paired convex portions 43 in the short-side direction. Each insertion hole 143B has an inner diameter substantially equal to the outer diameter of the bush 135. Each bush 135 through which the shaft part 45B of the bolt 45 is inserted is inserted into the insertion holes 143B.

Each bush 135 is cylindrical in shape and has a length that substantially equals the length of the insertion hole 143B formed in the convex portion 43, and has an outer diameter that substantially equals the inner diameter of the insertion hole 143B. Furthermore, each bush 135 has an inner diameter that substantially equals the outer diameter of the bolt 45.

The following will describe a step of assembling the damper 110 with the first base 130A and the second base.

First, the bushes 135 are respectively inserted into the insertion holes 143B of the base bodies 131.

Next, one of the joints 115 of the damper 110 is inserted between the paired convex portions 43 formed on the base body 131. The shaft part 45B of the bolt 45 is then inserted through the through hole 115A formed in the joint 115 of the damper 110 and the bushes 135 inserted into the insertion holes 143B of the base body 131, and the nut 47 is screwed onto the shaft part 45B of the bolt 45. The base body 131 is thus coupled to one of the joints 115 of the damper 110. The other joint 115 of the damper 110 is also coupled to the other base body 131 in the similar manner.

Then, the slip preventing parts 37 are respectively fitted with the base bodies 131 coupled to both ends of the damper 110, so that the step of assembling the damper 110 with the first base 130A and the second base is finished.

In the damper 110, first base 130A and the second base thus assembled, the joints 115 are respectively rotatable relative to the shaft parts 45B of the bolts 45. Accordingly, both ends of the damper 110 are respectively coupled to the first base 130A and the second base so as to be rotatable about the rotation axes. Furthermore, since the bushes 135 are elastic bodies, the shaft parts 45B of the bolts 45 are inclined when the bushes 135 are elastically deformed. As a result, the damper 110 coupled to the first base 130A and the second base can be swung in the direction intersecting the rotation direction.

As described above, the overturn preventing device of the second embodiment includes the damper 110 and the first base 130A and the second base. The damper 110 is mounted between the top surface of the furniture F installed on the floor, and the ceiling C. Both ends of the damper 110 are respectively coupled to the first base 130A and the second base so as to be rotatable about the rotation axes. Furthermore, both ends of the damper 110 are respectively coupled to the first base 130A and the second base so as to be swingable in the direction intersecting the rotation direction. Furthermore, the first base 130A abuts against the top surface of the furniture F and the second base abuts against the ceiling C.

In this overturn preventing device, both ends of the damper 110 are respectively coupled to the first base 130A and the second base so as to be rotatable about the rotation axes and swingable in the direction intersecting the rotation direction. As a result, even when the furniture F is shaken in the direction intersecting the rotation direction by shaking of earthquake or the like, the damper 110 is swung in the direction intersecting the rotation direction with the result that the first base 130A and the second base can respectively be maintained in abutment against the top surface of the furniture F and the ceiling C. When the furniture F is tilted in the direction parallel to the rotation direction of the damper 110, the damper 110 is rotated about the rotation axes so that the damping force of the damper 110 acts on the furniture F thereby suppressing tilt of the furniture F, with the result that the furniture F can be prevented from overturn. In other words, the first base 130A and the second base can be respectively maintained in abutment against the top surface of the furniture F and the ceiling C against earthquake or the like with multidirectional shaking, with the result that the furniture F can be prevented from overturn.

Accordingly, the overturn preventing device of the second embodiment can maintain the mounted state against earthquake or the like with multidirectional shaking, thereby preventing the furniture F from overturn.

Furthermore, the first base 130A and the second base of the overturn preventing device of the second embodiment are respectively formed with the insertion holes 143B through which both ends of the shaft parts 45B of the bolts 45 are inserted thereby to be supported. Furthermore, the bushes 135 through which the shaft parts 45B of the bolts 45 are respectively inserted are inserted into the insertion holes 143B. As a result, by the elastic deformation of the bushes 135 inserted through the insertion holes 143B, the shaft parts 45B of the bolts 45 can be inclined so that the damper 110 can be swung in the direction intersecting the rotation direction. Thus, the damper 110 is coupled to the first base 130A and the second base so as to be rotatable and swingable by a simple structure, with the result that the overturn preventing device can maintain the mounted state against earthquake or the like with multidirectional shaking, thereby preventing the furniture F from overturn.

### Third Embodiment

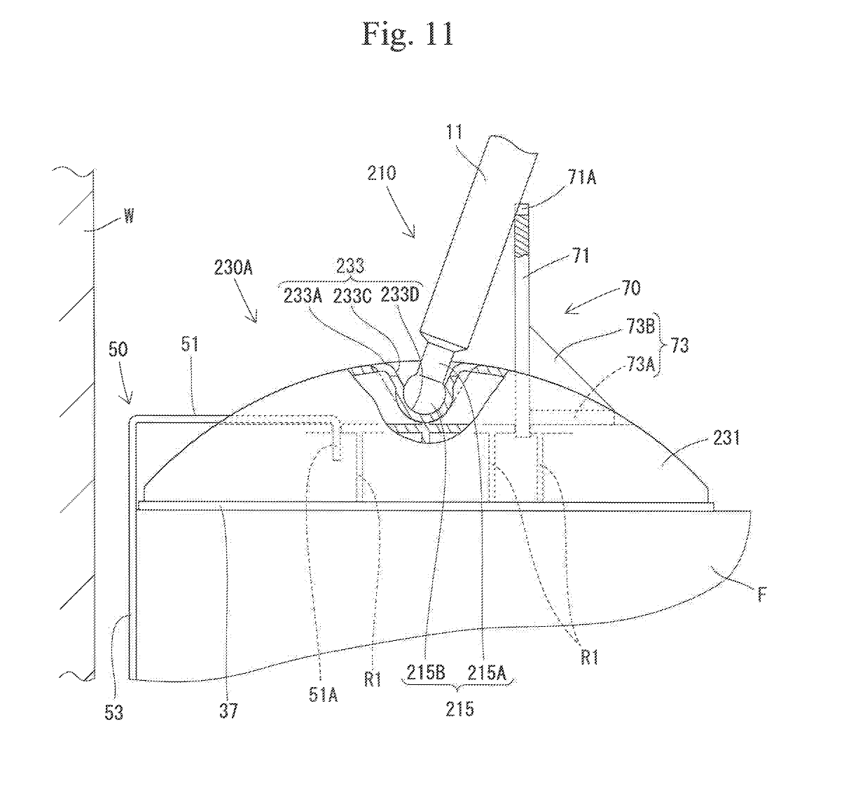

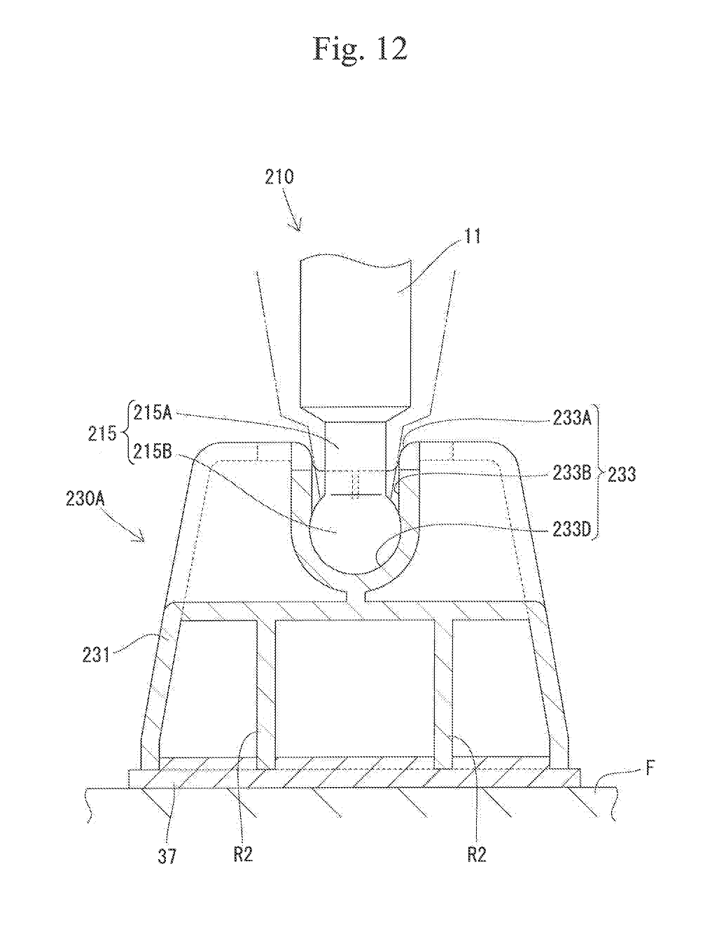

The overturn preventing device of a third embodiment differs from those of the first and second embodiments in the form of a joint 215 of a damper 210 and the form of a base body 231, as illustrated in FIGS. 11 and 12. Other components are same as those of the first and second embodiments. Identical or similar parts are labeled by the same reference symbols as those in the first and second embodiments, and the detailed description of these parts will be eliminated.

Furthermore, the manner of mounting the overturn preventing device of the third embodiment between the top surface of the furniture F and the ceiling C is same as that of the first and second embodiments.

In this overturn preventing device, each of two joints 215 respectively provided on both ends of the damper 210 includes a columnar stud 215A connected to the bottom of the cylinder 11 or the distal end of the rod and a spherical ball 215B continuous from a distal end of the stud 215A.

The first base 230A placed in abutment on the top surface of the furniture F and the second base (not illustrated) abutting against the ceiling C have the same form and the same structure, and each base includes the base bodies 231 and the slip preventing part 37.

In the first base 230A placed in abutment on the top surface of the furniture F, the base body 231 has a socket 233 formed by recessing a central part in long side direction of an upper surface thereof. The socket 233 includes an upper end opening 233A, right and left side walls 233B, front and rear side walls 233C, and a lower side wall 233D. The upper end opening 233A has a substantially long and round shape and is long in the long side direction. The upper end opening 233A has long sides extending in parallel to each other and short sides bulging to be curved outwardly. The right and left side walls 233B are downwardly extend substantially in parallel to each other continuously from long sides of the upper end opening 233A. A distance between the opposed right and left side walls 233B is longer than a diameter of the stud 215A of the joint 215. The front and rear side walls 233C extend continuously from the short sides of the upper end opening 233A in a manner such that the distance between the walls gradually narrows downwardly. The lower side wall 233D is continuous from lower ends of the right and left side walls 233B and lower ends of the front and rear side walls 233C and is formed into a curved surface which is brought into spherical contact with the ball 215B of the joint 215.

The damper 210 is assembled to the first base 230A and the second base by fitting the balls 215B of the joints 215 into the lower side walls 233D of the sockets 233 of the respective base bodies. In other words, the first base 230A and the second base are respectively coupled to the joints 215 of the damper 210 by the ball joints 215 and 233.

In this overturn preventing device, the damper 210 is rotatable in the direction along the long sides of the upper end opening 233A of the socket 233 (in the right-left direction in FIG. 11). In other words, both ends of the damper 210 are respectively coupled to the first base 230A and the second base so as to be rotatable with the centers of the balls 215B of the joints 215 serving as rotation axes. Furthermore, the damper 210 can be swung in the direction intersecting the rotation direction (the right-left direction in FIG. 12) since the distance between the right and left side walls 233B of the socket 233 is longer than the diameters of the stud 215A of the joint 215.

As described above, the overturn preventing device of the third embodiment includes the damper 210, the first base 230A and the second base. The damper 210 is mounted between the top surface of the furniture F installed on the floor, and the ceiling C. Both ends of the damper 210 are respectively coupled to the first base 230A and the second base so as to be rotatable about the rotation axes. Furthermore, both ends of the damper 210 are respectively coupled to the first base 230A and the second base so as to be swingable in the direction intersecting the rotation direction. Furthermore, the first base 230A abuts against the top surface of the furniture F and the second base abuts against the ceiling C.

In this overturn preventing device, both ends of the damper 210 are respectively coupled to the first base 230A and the second base so as to be rotatable about the rotation axes and swingable in the direction intersecting the rotation direction. As a result, even when the furniture F is shaken in the direction intersecting the rotation direction by shaking of earthquake or the like, the damper 210 is swung in the direction intersecting the rotation direction with the result that the first base 230A and the second base can respectively be maintained in abutment against the top surface of the furniture F and the ceiling C. When the furniture F is tilted in the direction parallel to the rotation direction of the damper 210, the damper 210 is rotated about the rotation axes so that the damping force of the damper 210 acts on the furniture F thereby suppressing tilt of the furniture F, with the result that the furniture F can be prevented from overturn. In other words, the first base 230A and the second base can be respectively maintained in abutment against the top surface of the furniture F and the ceiling C against earthquake or the like with multidirectional shaking, with the result that the furniture F can be prevented from overturn.

Accordingly, the overturn preventing device of the third embodiment can maintain the mounted state against an earthquake or the like with multidirectional shaking, thereby preventing the furniture F from overturn.

Furthermore, in the overturn preventing device of the third embodiment, the first base 230A and the second base are respectively coupled to both ends of the damper 210 by the ball joints 215 and 233. As a result, the damper 210 is coupled so as to be rotatable and swingable relative to the first base 230A and the second base, so that the overturn preventing device can maintain the mounted state against earthquake or the like with multidirectional shaking, thereby preventing the furniture F from overturn.

The present invention should not be limited to the first to third embodiments described above with reference to the drawings, but the technical scope of the invention encompasses the following embodiments, for example.

(1) Although the overturn preventing device is mounted on the furniture in each of the first to third embodiments, the overturn preventing device may be mounted on an article such as a bookshelf or a refrigerator which has a possibility of overturn by shaking of earthquake or the like.
(2) Although the overturn preventing device is mounted on the furniture installed on the floor with its rear surface being opposed to the wall surface in each of the first to third embodiments, the overturn preventing device may be mounted on the furniture or the like installed on the floor without being adjacent to the wall surface.
(3) In each of the first to third embodiments, the bases respectively have the bushes through which the rotation shaft members are inserted, so that the damper is allowed to swing in the direction intersecting the rotation direction of the damper. However, another structure may be provided to allow the damper to swing in the direction intersecting the rotation direction.
(4) Although both ends of each bush have the inner peripheral surfaces diameters of which are outwardly enlarged in the first embodiment, the diameters may not be outwardly enlarged. In this case, the bushes may be elastic bodies so that the elastic deformation of the bushes should allow the damper to swing in the direction intersecting the rotation direction.
(5) Although the bushes are elastic bodies in the first embodiment, the bushes may not be elastic bodies.
(6) Although the compression damper is used in each of the first to third embodiments, a two-way damper may be used as long as it can exert a predetermined damping force in a contracting operation.
(7) Although the damper including a cylinder filled with a hydraulic fluid and a compressed gas is used in each of the first to third embodiments, a fluid-pressure damper using a cylinder filled with another fluid or another type of damper may be used as long as it can exert a predetermined damping force in a contracting operation.
(8) In each of the first to third embodiments, the cylinder is filled with the compressed gas so that an expansion force of the compressed gas acts in an extension direction. However, a force acting in the extension direction may be generated by another manner. Furthermore, the cylinder may not be filled with the compressed gas or the like, and no force may act in the extension direction.
(9) Forms of the bases should not be limited to those in the first to third embodiments.
(10) Although the overturn preventing device includes the fall preventing part in each of the first to third embodiments, the overturn preventing device may not include the fall preventing part. Furthermore, the fall preventing part may be formed integrally with the first base.
(11) Although the overturn preventing device includes the angle regulator in each of the first to third embodiments, the overturn preventing device may not include the angle regulator. Furthermore, although the angle regulator is detachably attached to the first base in the first embodiment, the angle regulator may be formed integrally with the first base or the cylinder of the damper.
(12) Although the overturn preventing device includes the fixing cord in each of the first to third embodiments, the overturn preventing device may not include the fixing cord. Furthermore, although the fixing cord is the string made of the chemical fiber in each of the first to third embodiments, the fixing cord may be made of a metal or another material as long as the fixing cord can be loosened or cut.
(13) In the second embodiment, the through hole of the joint has an inner diameter that is slightly larger than the outer diameter of the shaft part of the bolt so that the damper is rotatable about the shaft part of the bolt. However, the joint may be formed integrally with the shaft part of the bolt so that the shaft part of the bolt should be rotatable relative to the bushes whereby the damper should be rotatable about the rotation axis.
(14) In the third embodiment, the joint of the damper is formed with the stud and the ball and the base body is formed with the socket. However, the joint of the damper may be formed with the socket and the base body may be formed with the stud and the ball.

### EXPLANATION OF REFERENCE SYMBOLS

C . . . ceiling; F . . . furniture (article); 10, 110, 210 . . . damper; 30A, 30B, 130A, 230A . . . base (30A, 130A, 230A . . . first base, 30B . . . second base); 35, 135 . . . bush; 35B . . . inner peripheral surface (of both ends of the bush); 45, 47 . . . rotation shaft member (45 . . . bolt, 47 . . . nut); 143B . . . insertion hole; and 215, 233 . . . ball joint (215 . . . joint, 233 . . . socket).

1. An overturn preventing device comprising:
a damper to be mounted between a top surface of an article installed on an installation surface and a ceiling; and
a pair of bases to which both ends of the damper are respectively coupled so as to be rotatable about respective rotation axes and swingable in a direction intersecting a rotation direction, one of the bases being configured to abut against top surface of the article, the other base being configured to abut against the ceiling.

2. The overturn preventing device according to claim 1, wherein the bases respectively have:
rotating shaft members extending about the rotation axes and supporting both ends of the damper so that the damper is rotatable about the rotation axes; and
cylindrical bushes through which the rotating shaft members are respectively inserted, the bushes allowing the damper to swing in the direction intersecting the rotation direction.

3. The overturn preventing device according to claim 2, wherein the bushes are elastic bodies.

4. The overturn preventing device according to claim 2, wherein an end of the damper is coupled to the bush, and the bush has both ends having respective inner peripheral surfaces diameters of which are outwardly enlarged.

5. The overturn preventing device according to claim 3, wherein each base is formed with an insertion hole through which both ends of the rotating shaft member are inserted so that the rotating shaft member is supported, and the bush through which the rotating shaft member is inserted is further inserted into the insertion hole.

6. The overturn preventing device according to claim 1, wherein both ends of the damper are respectively coupled to the bases by ball joints.

7. The overturn preventing device according to claim 1, wherein the damper is mounted to have an axis line extending from the ceiling side to the top surface side of the article, to be downwardly inclined and to extend in parallel to a direction in which the article is tilted by shaking of earthquake or the like in a planar view as viewed from above.

8. The overturn preventing device according to claim 3, wherein an end of the damper is coupled to the bush, and the bush has both ends having respective inner peripheral surfaces diameters of which are outwardly enlarged.

9. The overturn preventing device according to claim 2, wherein the damper is mounted to have an axis line extending from the ceiling side to the top surface side of the article, to be downwardly inclined and to extend in parallel to a direction in which the article is tilted by shaking of earthquake or the like in a planar view as viewed from above.

10. The overturn preventing device according to claim 3, wherein the damper is mounted to have an axis line extending from the ceiling side to the top surface side of the article, to be downwardly inclined and to extend in parallel to a direction in which the article is tilted by shaking of earthquake or the like in a planar view as viewed from above.
